(19) United States
(12) Patent Application Publication
(10) Pub. No.: US 2013/0334925 A1
(43) Pub. Date: Dec. 19, 2013

(54) INTERIOR PERMANENT MAGNET TYPE ROTOR HAVING CONTINUOUS SKEW STRUCTURE

(71) Applicant: FANUC CORPORATION, Yamanashi (JP)

(72) Inventors: Hidetoshi UEMATSU, Yamanashi (JP); Yasuo KAWAI, Yamanashi (JP)

(73) Assignee: FANUC Corporation, Yamanashi (JP)

(21) Appl. No.: 13/866,140

(22) Filed: Apr. 19, 2013

(30) Foreign Application Priority Data
Jun. 15, 2012 (JP) 2012-136050

(51) Int. Cl. H02K 1/27

(52) U.S. Cl. CPC H02K 1/274
USPC 310/216.092

(57) ABSTRACT

An IPM type rotor having a continuous skew structure obtained by a simple means, without constituting a permanent magnet as a complicated shape and forming an inclined magnetizing pattern on the permanent magnet. A rotor core has a recess formed on an outer circumferential surface of the rotor core. The recess is formed so as to extend along a boundary line of magnetic poles of a desired skew structure. Therefore, even when each permanent magnet has the cuboid shape, the magnetic flux may be uniformed during the magnetic flux is transmitted through the magnetic steel plate having high permeability, whereby the magnetic flux within the gap having low permeability becomes dominant. As a result, the rotor having the continuous skew structure is obtained.

### BACKGROUND OF THE INVENTION

1. Field of the Invention

The present invention relates to an interior permanent magnet (IPM) type rotor, which has a continuous skew structure wherein a magnetic pole position is continuously skewed, and has a permanent magnet embedded into a rotor core.

2. Description of the Related Art

Generally, in a synchronous electric motor having a stator and a rotor, a phenomenon such as cogging torque or torque ripple, wherein torque is fluctuated during the rotor is rotated relative to the stator, may occur, whereby the rotor cannot be smoothly rotated. As a means for solving this problem, a continuous skew structure, wherein magnetic pole positions are shifted so that a boundary line between neighboring N- and S-poles is inclined relative to an axial direction of a rotation axis (or a shaft) of the rotor, is well known. By virtue of the continuous skew structure, the cogging torque or the torque ripple may be generated while being shifted so that the torque may be averaged and stabilized whereby the rotor may be smoothly rotated.

The rotor of the synchronous electric motor has a rotor core constituted by stacking magnetic steel plates formed by punching, etc., and a permanent magnet attached to an outer circumferential surface of the rotor core or embedded into the rotor core. In particular, in the IPM type rotor wherein the permanent magnet is embedded into the rotor core, a gap is formed between the stator and the rotor by means of the rotor core having relatively high dimensional accuracy and the inner surface of the stator core. Therefore, a significant effect is expected by the continuous skew structure. For example, the IPM type rotor is described in Japanese Unexamined Patent Publication (Kokai) No. 2007-228771, and this document describes that “one permanent magnet arranged in one hole portion is magnetized so that the permanent magnet has two poles and has a skew structure.”

Japanese Unexamined Patent Publication (Kokai) No. 2008-136352 discloses some rotors having a skew structure. For example, this document describes that “as shown in FIG. 1(b), a permanent magnet embedding hole 4 having a generally crank-shape which extends in the axial direction and is shifted in the circumferential direction at an intermediate portion thereof. Then, by inserting a parallelogram permanent magnet 2 into generally crank-shaped embedding hole 4, permanent magnet 2 may be skewed.”

Japanese Unexamined Patent Publication (Kokai) No. 10-174324 discloses a rotor having two kinds of permanent magnet members. For example, this document describes that “a permanent magnet piece 6, which is to be inserted into a generally a cuboid area formed by an opening 3 of a stacked rotor core 2, has a central major member 6a and sub members 6b positioned at the both ends of major member 6a. The magnetic flux density of the sub member is lower than that of the major member.”

A rotor, into which a permanent magnet having an arc-shaped cross-section is embedded, is well known. For example, Japanese Unexamined Patent Publication (Kokai) No. 2010-81676 describes that “into a rotor 1, a permanent magnet 7 having an arc-shaped cross-section is embedded, the center position of which is shifted in the circumferential direction.”

Further, Japanese Unexamined Patent Publication (Kokai) No. 2000-278895 discloses rotor wherein the position of a flux barrier is varied in a continuous or stepwise manner. For example, this document describes that “a flux barrier portion is formed so as to incline relative to an axial direction along which core units are stacked, so that the position of the flux barrier portion is varied in a continuous or stepwise manner relative to the axial direction. Therefore, the flux of the permanent magnet is inclined relative to the axial direction, whereby a skew may be arranged without inclining the orientation of the permanent magnet or inclining the magnetizing direction of the magnet as in the prior art.”

In the rotor of Japanese Unexamined Patent Publication (Kokai) No. 2007-228771, the outer circumference of the rotor core is cylindrical, the permanent magnet extends parallel to the axial direction, and only the magnetizing pattern is inclined so as to form the continuous skew structure. On the other hand, in the rotor of Japanese Unexamined Patent Publication (Kokai) No. 2008-136352, the permanent magnet is divided so that a division surface is inclined in the circumferential direction, and the divided permanent magnets have the different polarities. However, in these rotors, the thickness of the magnet is different from an ideal state, and thus output characteristics may be lowered (for example, an amount of generated flux may be lowered and/or a magnetizing rate may be deteriorated).

In the rotor of Japanese Unexamined Patent Publication (Kokai) No. 10-174324, the parallelogram permanent magnet is inserted into the cuboid area. However, the magnetic flux generated at the magnet may be uniformed until reaching a gap surface, by being transmitted through the magnetic steel plate having high permeability. Therefore, it is difficult to obtain the effect of the continuous skew at the gap surface.

In the rotor of Japanese Unexamined Patent Publication (Kokai) No. 2010-81676, the rotor core is constituted as the continuous structure, and the hole, into which the magnet is inserted, has outer and inner circumferential surfaces having the same center as the rotation center of the rotor. Further, the magnet has the same shape as the hole. However, since the magnet has the complicated shape having the curved surface, the manufacturing cost of the magnet, which is manufactured by cutting a cuboid material in many cases, may be high.

In the rotor of Japanese Unexamined Patent Publication (Kokai) No. 2000-278895, the rotor core is constituted as the continuous structure, and the hole, into which the magnet is inserted, has outer and inner circumferential surfaces having the same center as the rotation center of the rotor. Further, the magnet has the same surfaces as the outer and inner circumferential surfaces, and is positioned parallel to the axial direction. However, in such a configuration, the amount of the magnet inserted into the hole is reduced when a skew angle is relatively large, whereby the output characteristic of the motor may be lowered.

### SUMMARY OF THE INVENTION

Thus, the object of the present invention is to provide an IPM type rotor having a continuous skew structure obtained by a simple means, without constituting a permanent magnet as a complicated shape and forming an inclined magnetizing pattern on the permanent magnet.

The present invention provides an interior permanent magnet type rotor comprising: a rotor core constituted by stacking magnetic steel plates; and a plurality of permanent magnets embedded into the rotor core, each of the permanent magnets having a cuboid shape, wherein a recess is formed on an outer circumferential surface of the rotor core, the recess extending on the circumferential surface while having a portion which extends non-parallel to an axial direction of the rotor so that a continuous skew structure is formed on at least a part of the rotor.

In a preferred embodiment, the recess extends on the outer circumferential surface of the rotor core as a polygonal line.

In a preferred embodiment, the recess extends on the outer circumferential surface of the rotor core as a polygonal line, while partially having a portion which extends parallel to the axial direction of the rotor.

### BRIEF DESCRIPTION OF THE DRAWINGS

The above and other objects, features and advantages of the present invention will be made more apparent by the following description of the preferred embodiments thereof, with reference to the accompanying drawings, wherein:

FIG. 1 is a view of a general configuration of an IPM type rotor according to the present invention;

FIG. 2 is a view schematically showing the rotor of FIG. 1;

FIG. 3 is a view schematically showing a rotor having a continuous skew structure wherein a skew angle is reversed at an intermediate portion of the continuous skew structure;

FIG. 4 is a view schematically showing a rotor constituted by connecting the rotors of FIG. 3 in the axial direction;

FIG. 5 is a view schematically showing a rotor having a continuous skew structure which partially includes a non-skew portion; and

FIG. 6 is a view schematically showing another rotor having a continuous skew structure which partially includes a non-skew portion.

### DETAILED DESCRIPTION

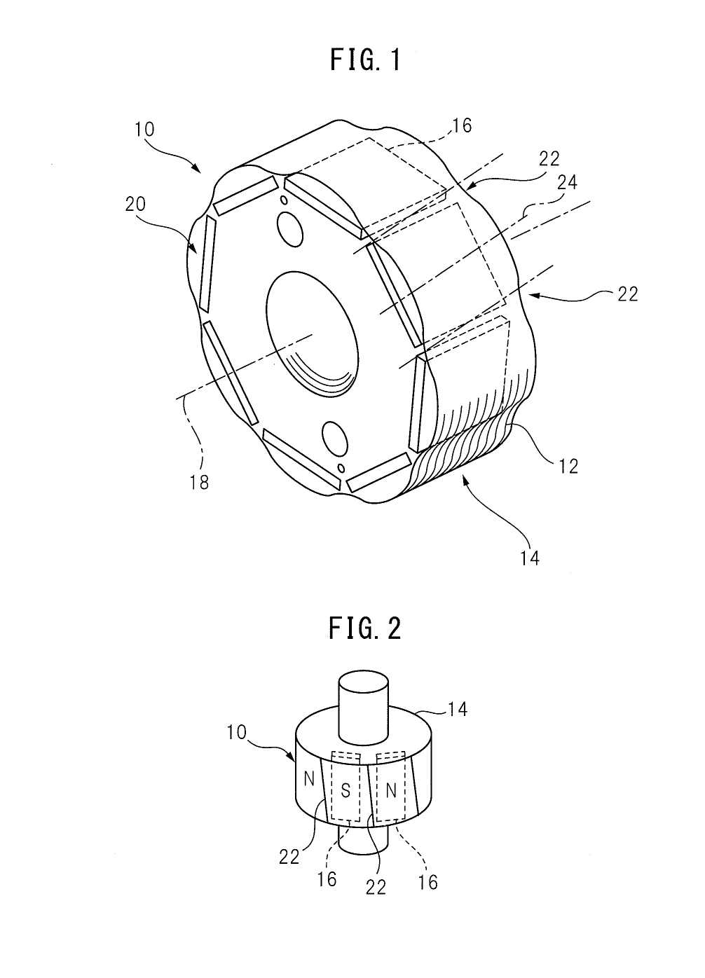

FIG. 1 is a schematic view of an interior permanent magnet (IPM) type rotor 10 according to a preferred embodiment of the present invention. Rotor 10 has a rotor core 14 constituted by stacking generally circular magnetic steel plates 12, and a plurality of (eight in the embodiment) permanent magnets 16 embedded into rotor core 14. Each permanent magnet 16 has a generally cuboid shape, and preferably each magnet has the same shape. For example, permanent magnet 16 is a neodymium magnet. Permanent magnet 16 has generally the same length as an axial length of rotor core 14. Each permanent magnet 16 is inserted into a magnet insert hole or slot 20 which extends in the direction of a rotation axis 18 of rotor core 14, so that N- and S-poles are alternately positioned at a predetermined angular intervals (45 degrees in the embodiment) about rotation axis 18.

Rotor core 14 has a recess 22 formed on an outer circumferential portion (surface) of the rotor core. Recess 22 is formed so as to extend along a boundary line of magnetic poles of a desired skew structure. In detail, when rotor 10 is to be formed as a continuous skew structure having a constant skew angle, as shown in FIG. 2, by forming recess 22 so as to extend along the boundary line between neighboring N- and S-poles, a desired continuous structure can be obtained.

In other words, recess 22 does not extend parallel to rotation axis 18, and is configured so that a deepest portion of recess 22 extends along the boundary line of each pole of the desired skew structure. Generally, in the synchronous electric motor, the magnetic flux of the rotor side is generated at the gap between the rotor core and the stator core (not shown). By forming recess 22 on the outer circumferential surface of rotor core 14, a generally intermediate portion (a ridge line 24 in the illustrated embodiment) corresponds to the center of each pole. Therefore, even when each permanent magnet 16 has the cuboid shape, the magnetic flux may be uniformed during the magnetic flux is transmitted through the magnetic steel plate having high permeability, whereby the magnetic flux within air (or the gap) having low permeability becomes dominant. As a result, the rotor having the continuous skew structure, in which the pole position is continuously skewed in the rotational direction, can be obtained. Accordingly, the desirable skew structure can be easily obtained, without forming the permanent magnet into a complicated shape corresponding to the skew structure, or without forming a magnetizing pattern corresponding to the skew structure on the permanent magnet.

Although recess 22 in FIG. 1 has a smooth groove shape (having no sharp edge), recess 22 may have any shape as long as the gap between the stator and the recess is larger than a gap between the stator and a portion of the rotor other than the recess. For example, recess 22 may have a sharp edge, etc.

As described above, in the present invention, the continuous skew structure is defined by the shape of the recess. Therefore, each permanent magnet 16 may be formed as a simple cuboid shape which can be easily manufactured, and it is not necessary to position each permanent magnet relative to rotor core 14 with high accuracy. As schematically shown in FIG. 2, each permanent magnet 16 is positioned so that each permanent magnet is included in a region defined by each skewed pole, while the polarity of the permanent magnet is the same as the skewed pole. In other words, each permanent magnet 16 is positioned so that each permanent magnet does not overlap regions of the neighboring poles (having the different polarities).

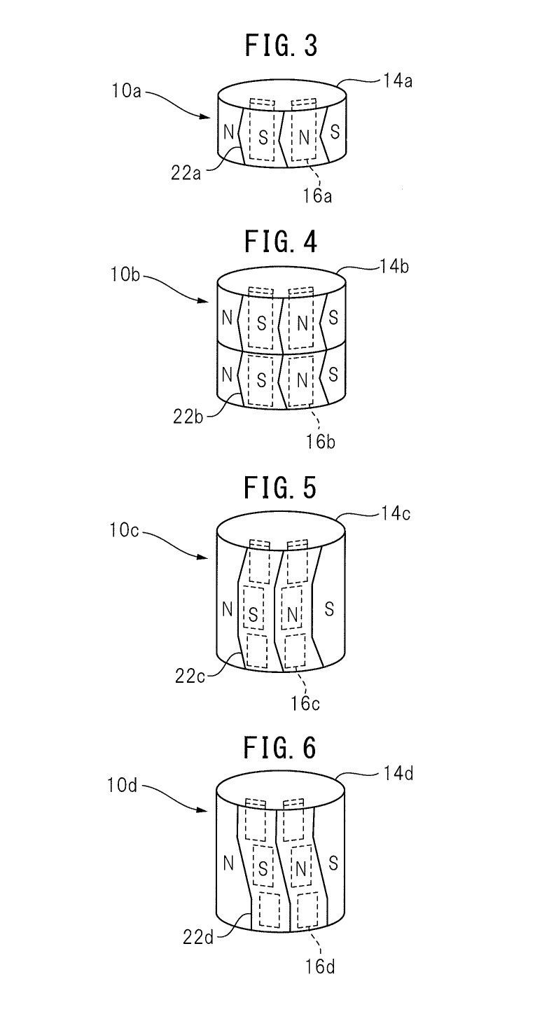

FIGS. 3 to 6 show various examples of the continuous skew structure, wherein the skew angle is not constant. First, a rotor 10a as shown in FIG. 3 has a configuration wherein a skew angle is discontinuously changed at a generally axial intermediate position of a rotor core 14a. Concretely, the skew angle is reversed so as to incline relative to the axial direction by the same angle. As described above, since the skew structure is formed by the recess on the outer circumferential surface of the rotor core in the invention, the skew structure having the reversed angles can be easily constituted by forming a recess 22a extending as a polygonal line on the outer circumferential surface of rotor core 14a. Each permanent magnet 16a has a length which is generally the same as an axial length of rotor core 14a. Also in this case, each permanent magnet 16a is positioned so that each permanent magnet is included in a region defined by each skewed pole, while the polarity of the permanent magnet is the same as the skewed pole. In other words, each permanent magnet 16a is positioned so that each permanent magnet does not overlap the neighboring poles.

A rotor 10b as shown in FIG. 4 has a configuration wherein two rotors 10a as shown in FIG. 3 are connected so that the poles of the rotors having the same polarity are aligned. Also in the example of FIG. 4, the skew structure having the reversed angles can be easily constituted by forming a recess 22b extending as a polygonal line on the outer circumferential surface of a rotor core 14b. Each permanent magnet 16b has a length which is generally the same as an axial length of rotor core 14b. Also in this case, each permanent magnet 16b is positioned so that each permanent magnet is included in a region defined by each skewed pole, while the polarity of the permanent magnet is the same as the skewed pole. In other words, each permanent magnet 16b is positioned so that each permanent magnet does not overlap regions of the neighboring poles. In addition, although each permanent magnet 16b is divided in the axial direction similarly to rotor core 14b in the drawing, each permanent magnet may be formed as one piece which has a length which is generally the same as the total axial length of rotor 10b.

A rotor 10c as shown in FIG. 5 has a configuration which partially includes a non-skew portion (wherein a boundary line between neighboring poles is a straight line parallel to the axial direction). Concretely, by means of a recess 22c extending as a polygonal line on the outer circumferential surface of a rotor core 14c, rotor 10c has a straight portion (or the non-skew portion) at an axial intermediate position thereof and continuous skew portions at both axial ends of the non-skew portion, wherein skew directions of the skew structures are opposed to each other. As such, even when the straight or non-skew portion is provided, a skew effect may be obtained by the skew portions, while the skew effect is reduced corresponding to a ratio of the straight portion to the whole. In addition, although each permanent magnet 16c may extend over the total axial length, each permanent magnet may be divided corresponding to the straight portion and the skew portion, so that each divided magnet is positioned at the generally the center of a region corresponding to each straight portion or each skew portion, as illustrated.

A rotor 10d as shown in FIG. 6 has another configuration which partially includes a non-skew portion. Concretely, by means of a recess 22d extending as a polygonal line on the outer circumferential surface of a rotor core 14d, rotor 10d has a skew portion at an axial intermediate position thereof and straight portions (or non-skew portions) at both axial ends of the skew portion. Also in this case, a certain skew effect may be obtained by the skew portion. In addition, although each permanent magnet 16d may extend over the total axial length, each permanent magnet may be divided corresponding to the straight portion and the skew portion, so that each divided magnet is positioned generally at the center of a region corresponding to each straight portion or each skew portion, as illustrated.

As described above, in the present invention, by forming the recess, which at least partially has the portion extending non-parallel to the axial direction, on the outer circumferential surface of the rotor core, the IPM type rotor, wherein the continuous skew structure is at least partially formed, can be constituted.

According to the present invention, the continuous skew structure can be obtained by the recess formed on the outer circumferential surface of the rotor core, while each permanent magnet embedded into the rotor core may have a simple cuboid shape. Therefore, the rotor, capable of reducing a cogging torque etc., can be manufactured at low cost.

By forming the recess formed on the outer circumferential surface of the rotor core as a polygonal line, the skew structure wherein the skew angle is changed at the intermediate portion thereof, or the skew structure having the non-skew portion, can be easily obtained.

While the invention has been described with reference to specific embodiments chosen for the purpose of illustration, it should be apparent that numerous modifications could be made thereto, by one skilled in the art, without departing from the basic concept and scope of the invention.

1. An interior permanent magnet type rotor comprising:
a rotor core constituted by stacking magnetic steel plates; and
a plurality of permanent magnets embedded into the rotor core, each of the permanent magnets having a cuboid shape,
wherein a recess is formed on an outer circumferential surface of the rotor core, the recess extending on the circumferential surface while having a portion which extends non-parallel to an axial direction of the rotor so that a continuous skew structure is formed on at least a part of the rotor.

2. The interior permanent magnet type rotor as set forth in claim 1, wherein the recess extends on the outer circumferential surface of the rotor core as a polygonal line.

3. The interior permanent magnet type rotor as set forth in claim 1, wherein the recess extends on the outer circumferential surface of the rotor core as a polygonal line, while partially having a portion which extends parallel to the axial direction of the rotor.
